(19) United States
(12) Patent Application Publication
(10) Pub. No.: US 2025/0085450 A1
(43) Pub. Date: Mar. 13, 2025

(54) DATA DRIVEN METHODS TO DEVELOP PORE BODY SIZE TO PORE THROAT TRANSFORMATION FOR COMPLEX RESERVOIRS

(71) Applicant: Halliburton Energy Services, Inc., Houston, TX (US)

(72) Inventors: Wei SHAO, Houston, TX (US); Songhua CHEN, Liberty Hill, TX (US)

(73) Assignee: Halliburton Energy Services, Inc., Houston, TX (US)

(21) Appl. No.: 18/244,508

(22) Filed: Sep. 11, 2023

(51) Int. Cl. G01V 3/32; E21B 49/00

(52) U.S. Cl. CPC G01V 3/32; E21B 49/00

(57) ABSTRACT

Described herein are systems and techniques for improving accuracies of determinations made using a nuclear magnetic resonance (NMR) sensing device when the NRM sensing device collects data in a wellbore. In certain instances, determinations made from NMR measurement data may not correspond to measurements made by other types of sensing equipment. For example, determinations of pore sizes made from evaluating sets of capillary pressure data may not correspond to determinations made from data sensed during an NMR test. Since the accuracy of determinations regarding wellbore petrophysical parameters made from data sensed by sensing equipment can affect the efficiency and profitability of a wellbore operation, and since NMR sensing devices are more deployable in a wellbore than other forms of test equipment, systems and techniques of the present disclosure are directed to improving the accuracy of petrophysical parameters determinations made from data sensed by NMR sensing devices.

### TECHNICAL FIELD

The present disclosure is generally directed to evaluating data collected by a nuclear magnetic resonance (NMR) sensing device. More specifically, the present disclosure is directed to correlating data sensed by an NMR sensing device with data collected by another type of sensing device.

### BACKGROUND

When managing oil and gas drilling and production environments (e.g., wellbores, etc.) and performing operations in the oil and gas drilling and production environments or in environments where compounds may be sequestered, it is important to obtain measurements, other sensor data, and details regarding Earth formations and conditions in the vicinity of a wellbore. Such data may be used to understand downhole conditions and help manage the wellbore and associated operations. For example, sensor data can be used to identify features within the Earth formations and whether the Earth formations are stable and are being used in a controlled way. However, the downhole conditions and constraints can create significant challenges in deploying systems such as sensors and monitoring conditions downhole. Furthermore, certain types of Earth formations may increase errors or uncertainty of determinations made by a computer model from sensed data.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology;

FIG. 1B is a schematic diagram of an example downhole environment having tubulars, in accordance with various aspects of the subject technology;

FIG. 2 shows how the directions of spins of protons included in a sample align when exposed to an external magnetic field;

FIG. 3 includes two different images, a first image where proton spins of a sample are aligned with an applied static magnetic field and a second image where proton spins of the sample respond to radio frequency signals transmitted by an NMR device, in accordance with various aspects of the subject technology;

FIG. 4 illustrates two different plots of data collected from a same set of same carbonate rock samples, in accordance with various aspects of the subject technology;

FIG. 5 illustrates a ratio of geometric mean pore throat values versus geometric mean T2 values of FIG. 4, in accordance with various aspects of the subject technology;

FIG. 6 illustrates comparisons of partial porosities derived from measured capillary pressure pore throat distributions and a set of converted pore throat distributions with the defined cutoffs for pore throat size distributions, in accordance with various aspects of the subject technology;

FIG. 7 includes two different graphs of plots that represent the decomposition of pore throat size distribution and NMR T2 distribution using factor analysis, respectively generated using analytical methods in accordance with various aspects of the subject technology;

FIG. 8 illustrates the results of organizing the data of FIG. 7 into respective sets of Gaussian distributions, in accordance with various aspects of the subject technology;

FIG. 9 illustrates actions that may be performed when factors are identified that allow data collected by a nuclear magnetic resonance (NMR) device to be adjusted to correspond to data associated with pores contained within rocks, in accordance with various aspects of the subject technology;

FIG. 10 illustrates an example computing device architecture which can be employed to perform various steps, methods, and techniques disclosed herein.

### DETAILED DESCRIPTION

Described herein are systems, apparatuses, processes (also referred to as methods), and computer-readable media (collectively referred to as “systems and techniques”) for improving an accuracy of determinations made using data sensed in a wellbore. In certain instances, determinations made from NMR measurement data may not correspond to measurements made by other types of sensing equipment. For example, determinations of pore sizes made from evaluating sets of capillary pressure data may not correspond to determinations made from data sensed during an NMR test. Since the accuracy of determinations regarding wellbore petrophysical parameters made from data sensed by sensing equipment can affect the efficiency and profitability of a wellbore operation, and since NMR sensing devices are more deployable in a wellbore than other forms of test equipment, systems and techniques of the present disclosure are directed to improving the accuracy of petrophysical parameters determinations made from data sensed by NMR sensing devices. The present disclosure is directed to correlating data sensed by an NMR sensing device with data collected by another type of sensing device for purposes that may include establishing an interpretation model for predicting the second sensing device's deliverable using data sensed by the NMR sensing device.

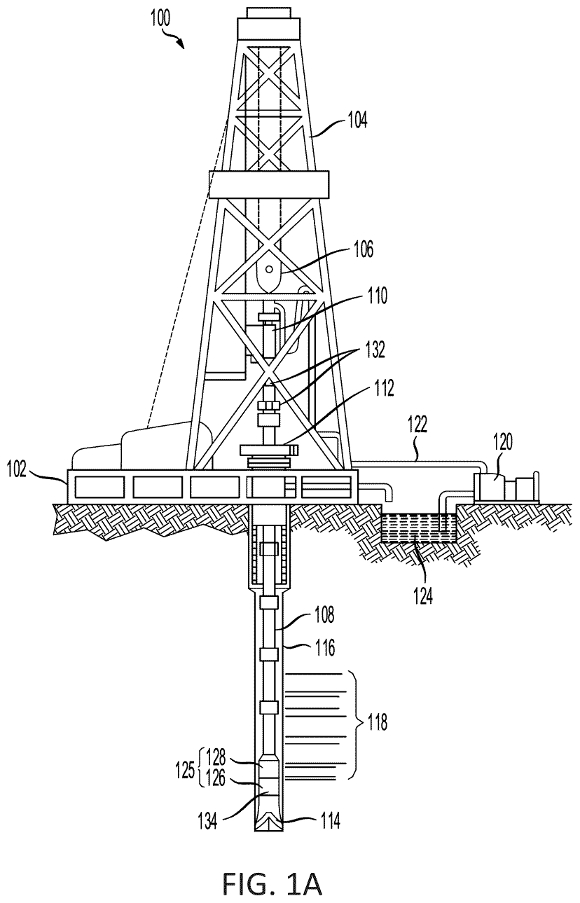

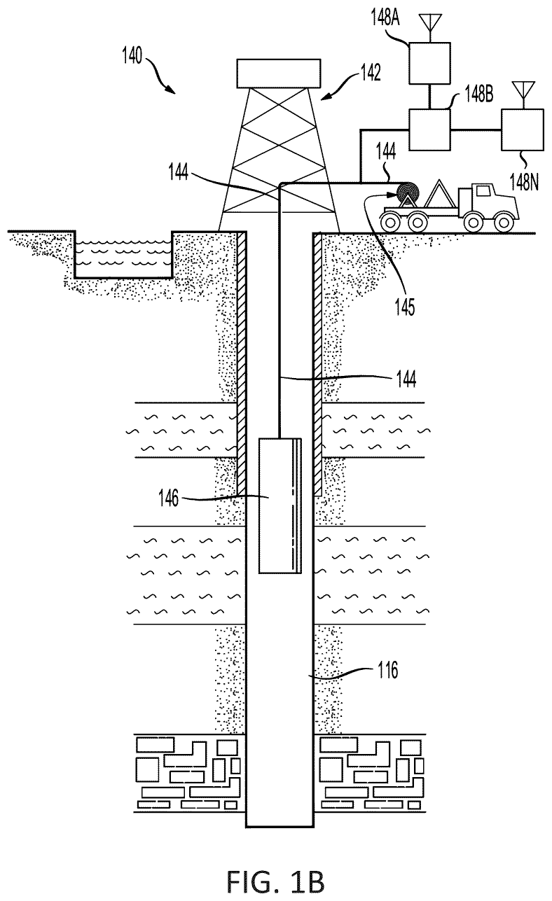

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an electromagnetic imager tool (not shown) as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. An electromagnetic imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via the wireline conveyance 144 to meet power requirements of the tool. For slickline or coiled tubing configurations, power can be supplied downhole with a battery or via a downhole generator.

As mentioned above, one type of equipment that may be used to collect data in a wellbore is a nuclear magnetic resonance (NMR) sensing device. When an NMR sensing device is deployed in a wellbore, a magnetic field provided by a magnet of the NMR sensing device aligns at least some of the protons (e.g., protons of hydrogen atoms) in materials that are near the NMR sensing device. The spins of protons affected by the magnetic field may align in one of two directions, a first direction, the −1/2 spin state, that is associated with a first energy state and in a second direction, the +1/2 spin state, that is associated with a second energy state.

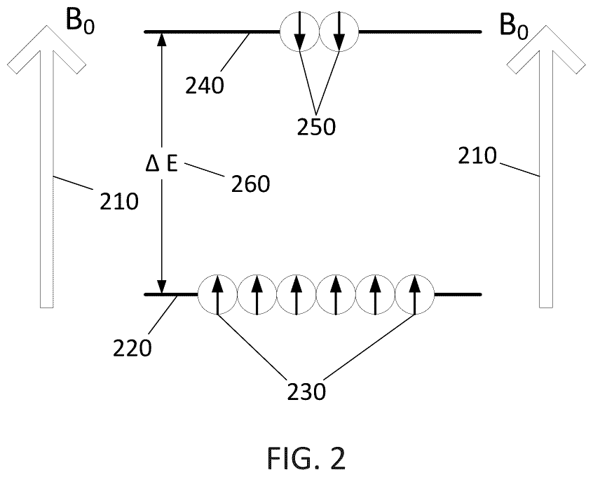

FIG. 2 shows how the directions of spins of protons included in a sample align when exposed to an external magnetic field. FIG. 2 includes magnetic field 210 that has a field strength B0. When magnetic field 210 is applied to the sample and given sufficient time, affected protons in hydrogen or potentially in other types of atoms of the sample will align with the magnetic field 210 in either the −1/2 spin state or the +1/2 spin state. Protons 230 are illustrated as circles with arrows pointing in an upwards direction, these upward arrows indicate that protons 230 are in the +1/2 spin state. Protons 250 are illustrated as circles with arrows pointing in a downward direction, these downward arrows indicate that protons 250 are in the −1/2 spin state. Lines 220 and 240 are energy states respectively associated with spins of protons 230 and 250. A value of energy ΔE (260) that separates the higher energy −1/2 spin state from the lower energy +1/2 spin state will increase with a value of applied magnetic field B0. Note that there are more protons at the lower energy +1/2 spin state (e.g., protons 230) than protons that are at the higher energy −1/2 spin state (e.g., protons 250). The number of protons 230 at the lower energy state and the number of protons 250 at the higher energy state may correspond to a Boltzmann distribution, where the state distributions of protons at different energy states may vary as a function of temperature. Before a magnetic field is applied to a sample, the spins of protons included in that sample may be randomly distributed and the sample may have a net magnetic field of zero. As mentioned above, when a sample is placed in a magnetic field, at least some protons within the sample will align with the magnetic field. The amount of time it takes for the spins of protons to settle into alignment with the magnetic field (T1 time) may vary based on specific compounds that are included in the sample. Some non-limiting, illustrative examples of alignment times include three seconds and five seconds.

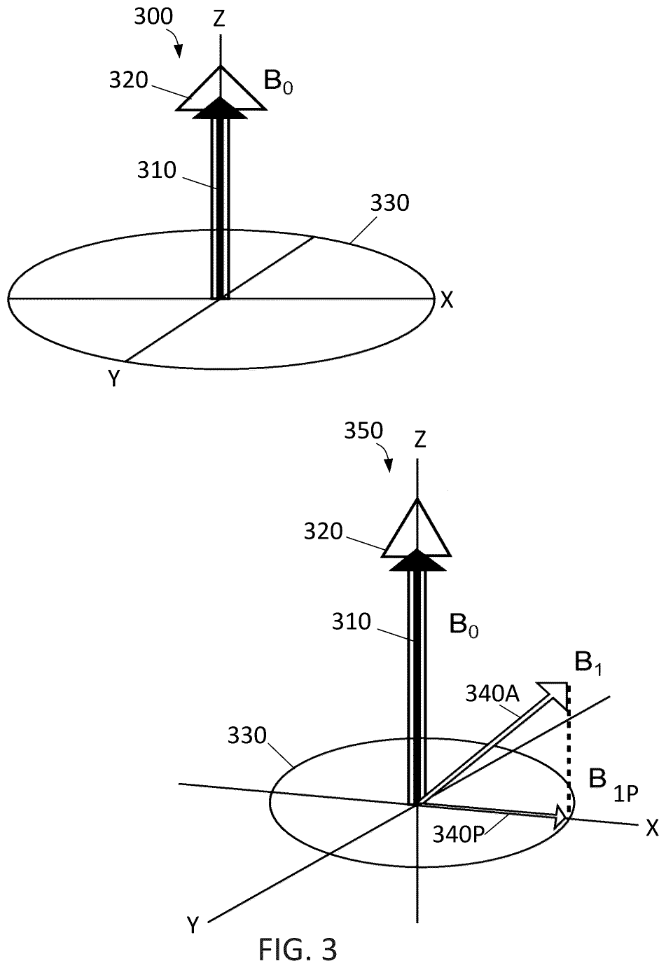

FIG. 3 includes two different images, a first image where proton spins of a sample are aligned with an applied static magnetic field and a second image where proton spins of the sample respond to radio frequency signals transmitted by an NMR device. FIG. 3 includes image 300 where applied magnetic field 310 of field strength B0 is used to align the spins of protons in a sample parallel to the Z axis of image 300. A magnitude of vector 320 in image 300 may correspond to net (total parallel magnetic moment (of protons 230 of FIG. 2) and total anti-parallel magnetic moment (of protons 250 of FIG. 2) magnetic moments of proton spins that are parallel to applied magnetic field 310. Image 300 also includes an X axis and a Y axis that form plane 330.

After the spins of protons included in the sample are aligned with applied magnetic field 310, RF signals may be emitted by the NMR sensing device. Magnetic fields associated with these RF signals may affect the orientation of spins of the protons in a sample. A greater amount of energy of an RF pulse will result in a greater proton spin response. An amount of response in these spins may vary with a duration of the RF signal or with RF signal amplitude. Image 350 illustrates an instance where the net magnetic moment of spin is rotated with an offset angle from this Z axis as indicated by vector 340A. An angle associated with a change in spin direction may be referred to as a tipping angle. Antennas at the NMR sensing device sense changes in the spins of protons by measuring changes in electromagnetic fields along plane 330 may be referred to as RF field B1, 340P is the corresponding component perpendicular to B0, which is responsible for tipping proton spins.

RF signals with different energies may be used to affect the spins of protons by different amounts. The transmission of a first RF signal toward a sample may result in the angles of proton spins in the sample being changed by 90 degrees. As such, this first RF signal may be classified as a 90 degree RF signal pulse (or excitation pulse) that induces a 90 degree tipping angle. Similarly, the transmission of a second RF signal toward the sample may result in the angles of proton spins in the sample being changed by 180 degrees. Because of this, the second RF signal may be classified as a 180 degree RF signal pulse (or refocus pulse) that induces a 180 degree tipping angle. Since the tipping angle varies with RF signal energy, the 90 degree RF pulse may be twice as long or have twice the amplitude of the 180 degree pulse when tipping angle varies linearly with applied RF signal energy. NMR sensing devices may use other types of RF signal pulses. For example, a type of signal pulse that depolarizes (or randomizes) protons spins may be referred to as a chirp.

Operation of an NMR sensing device may include aligning protons in an applied magnetic field for a period of time, transmitting one or more RF signal pulses, and making one or more measurements by the NMR sensing device. This process may be repeated using different lengths of time period. Evaluations may then be performed to identify materials that are present in the sample based on known correspondences between the transmitted RF signal pulses and the measurements made by the NMR sensing device.

Permanent magnets can be used as a source of the applied magnetic field that an NMR device uses. The strength of a magnetic field of a permanent magnet varies with temperature. As temperature increases, the magnetic field strength of a particular permanent magnet will tend to reduce. Since environmental temperatures of a wellbore vary, the magnetic field strength of a magnet used in an NMR sensing device deployed in a wellbore will vary with the wellbore temperature.

Another factor that changes with magnetic field strength is the resonate frequency of protons included within a sample. The resonant frequency may also vary with distance that separates an NMR sensing device from substances. Because of this RF signal frequencies used to affect the spins of hydrogen or other sensitive protons may be varied to collect data associated with the substances that are located at these different distances.

Capillary pressure tests like a mercury injection capillary pressure (MICP) test may be used to identify factors that affect the petrochemical parameters of rocks. Such factors include pore throat size and pore body size. The term pore throat refers to a space located at a point where two grains of rock meet and that connects the point to larger pore volumes. The size of a pore throat (a pore throat size) corresponds to a radius of a circle drawn perpendicular to a flow of fluid that fits within a narrowest point of the pore. The term pore body size refers to gaps between grains of rock that form a space, the size of this space may be referred to as the body size of the pore (the pore body size). Data collected when a capillary pressure test is performed on rock samples may be evaluated to identify to one or more distributions that correspond to a porosity factor (e.g., pore throat size).

When an NMR device is used to identify porosity and/or other petrochemical parameters and a pore size distribution of rock samples, data collected by the NMR device may include NMR relaxation times (e.g., T1 and/or T2 times) that correspond to pore body sizes of the rock samples. In some instances, these pore body sizes which may correlate to pore throat sizes of MICP test data. For example, an NMR relaxation time distribution of fully brine saturated rocks may correlate, at least to some extent, to an actual pore throat distribution of the rock sample. In such instances, a correlation between NMR relaxation times and MICP pore throat sizes may be characterized using a constant conversion factor for all pore types. In other instances, however, an NMR relaxation time distribution may not linearly correlate to an MICP pore throat distribution. For example, in carbonate rocks with varying minerals, varying pore surface roughness, and/or varying pore to pore connectivity, NMR relaxation times may not identically correspond to MICP pore throat sizes. In such instances, peaks in plots of NMR data cannot be made to correspond to peaks in plots of MICP data using a constant conversion factor for all pore types.

Techniques of the present disclosure perform evaluations that may identify multiple conversion factors that could be used to align an NMR distribution with a MICP pore throat size distribution. To identify these multiple conversion factors, data may be collected using more than one type of sensing device or test. For example, a first set of data may be collected using an MICP test and a second set of data may be collected by an NMR device in a laboratory. Data from these respective tests may be associated with different types of pores, where each type of pore may be associated with a different range of pore sizes. For example, when the MICP test data is grouped into three different ranges of pore throat size and data from the NMR may be is grouped into three different sets of NMR relaxation times, three different conversion factors may be identified. Here a first conversion factor may align a first span of T2 time of the NMR data with a first span of pore throat sizes identified from the MICP data, a second conversion factor may align a second span of T2 time of the NMR data with a second span of pore throat sizes of the MICP data, and a third conversion factor may align a third span of T2 time of the NMR data with a third span of pore throat sizes of the MICP data. Data from an NMR test may be used to train computer models that align received NMR data using multiple different conversion factors. Because of this, data collected from NMR tests may be referred to as NMR training data.

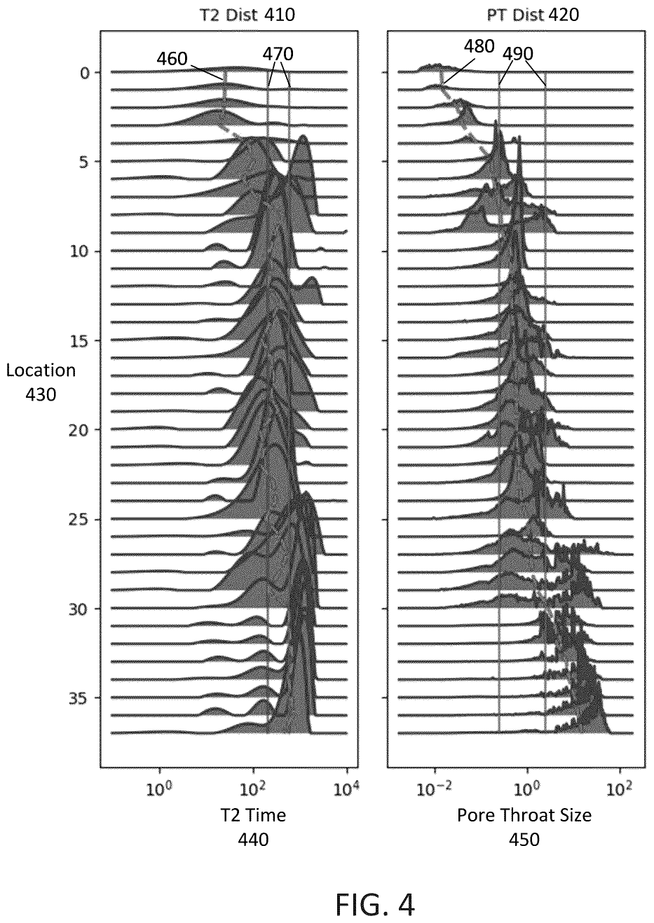

FIG. 4 illustrates two different plots of data collected from a same set of same carbonate rock samples (e.g., core samples). FIG. 4 includes T2 time distribution plot 410 and pore throat distribution plot 420. Each of the two different plots 410 and 420 have a vertical axis 430 that identifies pseudo locations of the rock sample. Values of vertical axis is a location scale includes values that vary from 0 to 37. Plot 410 has a horizontal axis of T2 time 440 measured by an NMR device and the horizontal axis of plot 420 identifies pore throat size measured by a capillary pressure test.

Data in each of the plots 410 and 420 include features that appear as bumps that appear similar in shape to waves that have varying height along horizontal axis 440 and 450. These features identify the changes of pore body sizes and pore throat sizes of the rock sample from NMR data and MICP data. These values may be referred to as data points of T2 times or port throat size. Line 460 of plot 410 and line 480 of plot 420 identify where geometric means of data points are located along the vertical axis of plots 410 and 420. As such line 460 is a geometric mean of T2 data (T_{2GM}) and line 480 is a geometric mean of pore throat size data (PT_{GM})

Plot 410 includes a set of two vertical lines 470 between which a portion of the T2 data of plot 410 is located. Plot 420 includes a set of two vertical lines 490 between which a portion of the pore throat size data is located. These lines are used to divided NMR T2 relaxation time, and MICP pore throat size into three sections which corresponding to three pore types: micro, meso, and macro.

A formula consistent with equation 1 below may be used to identify a factor that can be used to convert T2 distribution data to pore throat distribution data. Equation 1 may be applied when a single or constant conversion factor is used. Multiple formulas may have to be applied with multiple conversion factors are used.

$$Single Conversion Factor Formula$$

$$1 / {T}_{2 GM} = ρ G / {R}_{bt , GM} \cdot ( 1 / {pts}_{GM} ) \qquad Equation 1$$

Here, R_{bt,GM} is the pore body geometric mean, pts_{GM} is the pore throat size geometric mean, R_{bt,GM}=pbs_{GM}/pts_{GM}, ρ a measure of surface relaxivity, and G a geometric factor. Furthermore, the term GM may refer to a geometric mean. While conceptually using a single conversion factor is straightforward, it hides a very likely scenario that ρ may not be a constant over the entire pore system in one formation depth or one core plug sample. As mentioned above, FIG. 4 shows T2 distribution plot 410 and pore throat distribution plot 420 of carbonate rock samples, overlayed with geometric mean lines 460 of T_{2GM} and 480 of PT_{GM}. Values of PT_{GM} may be sorted according to the rank of PT_{GM}. The two solid vertical lines 480 and 490 in each of plots 410 and 420 may be referred to as the micro and macro cutoffs for NMR T2 time spans and MICP pore throat size spans, respectively. The constant conversion factor from T2 time spans and MICP pore throat size spans can be approximated by the ratios of the geometrical means of MICP port throat distribution PT_{GM} to the geometrical means of NMR T2 distribution T_{2,GM}, designated as PT_{GM}/T_{2,GM}.

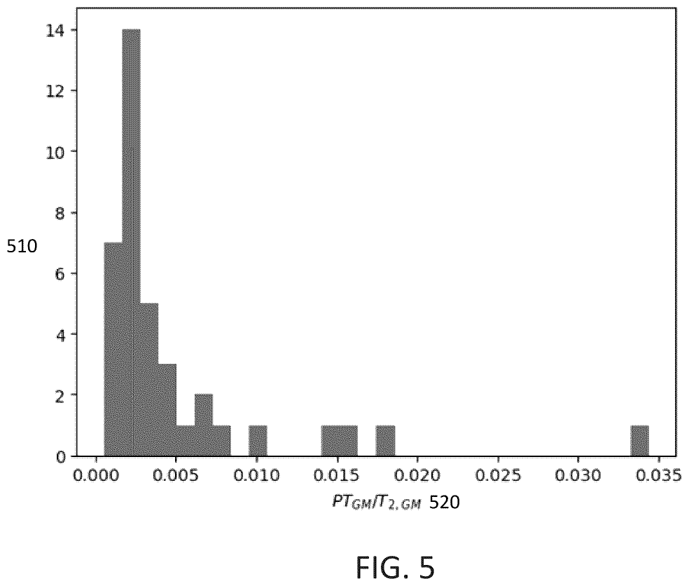

FIG. 5 illustrates a ratio of geometric mean pore throat values versus geometric mean T2 values of FIG. 4. The horizontal axis of FIG. 5 corresponds to values of PT_{GM}/T_{2,GM} and the vertical axis corresponds to number of samples. The most frequent ratio is about 0.00224 microns/ms. However, FIG. 5 also shows there are a few samples whose PT_{GM}/T_{2,GM} ratios deviate from 0.00224 significantly. It clearly shows that a constant linear conversion factor assumption may not hold true for this complex reservoir, suggesting that the single R_{bt,GM} may be overly simplified for the reservoir. As such variations in distributions may indicate that more than one conversion factor should be used when collected data is evaluated.

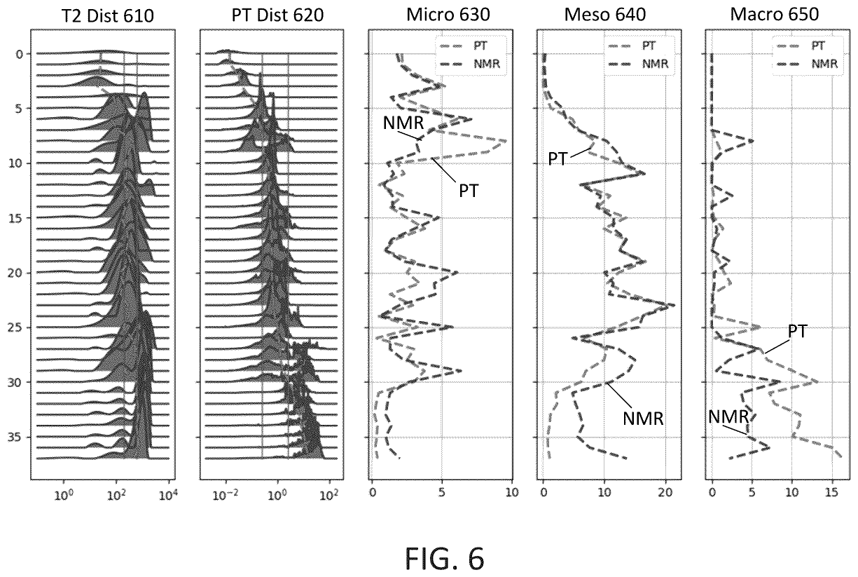

FIG. 6 illustrates comparisons of partial porosities derived from measured capillary pressure pore throat distributions and a set of converted pore throat distributions with the defined cutoffs for pore throat size distributions. Pore sizes of a sample or a rock formation may be separated into three different size spans, a micro size span, a meso size span, and a macro size span. A micro size span may include pore throat sizes that are less than 0.5×10⁻1 microns, a meso size span may include pore throat sizes that are between 0.5×10⁻1 microns and 0.5 microns, and a macro size span may include pore throat sizes that are larger than 0.5 microns, for example. The T2 distribution plot 610 and the PT distribution plot 620 of FIG. 6 may be the same T2 and PT distribution plots discussed in respect to FIG. 4.

Plots 630, 640, and 650 each include a first line associated with NMR data (NMR) and a second line that corresponds to pore throat size data (PT) when a single conversion factor was used to align NMR data (NMR plots in FIG. 6) with pore throat size data (PT plots in FIG. 6). Plot 630 is associated with micro pore throat sizes, plot 640 is associated with meso pore throat sizes, and plot 650 is associated with macro pore throat sizes. Note that the three different sets of NMR vs PT curves in plots 630, 640, and 650 track do not always track either other. In some areas these different curves have significantly different normalized values. This clearly shows that using a constant conversion factor can cause much larger discrepancies for portions of rock that include macro pore volumes.

To account for limitations associated with using a single conversion factor and to estimate partial porosities more accurately from NMR T2 distribution data, it is important to establish the pore type or pore size dependent conversion factors of the pore throat size (pts) to pore body size (pbs) distributions for such complex reservoirs. Techniques of the present disclosure may include applying analytical methods to both capillary pressure (e.g., MICP) data and NMR data based on associating this data with pore types or sizes or pore sizes. This may include identifying a set of one-to-one correlation values and applying them to respective portions of collected data.

Once data is collected from a set of rocks, that data may be analyzed using a set of analytical methods such that plots of the data that may be associated with the underlying features of the set of rocks. Such analysis can be factor analysis, for example, and plots of data made from this analysis may be referred to as factor analysis plots. While ideally, each of these extracted features or factor analysis plots should not overlap with other factor analysis plots, noise and limited data size may result in data that overlaps.

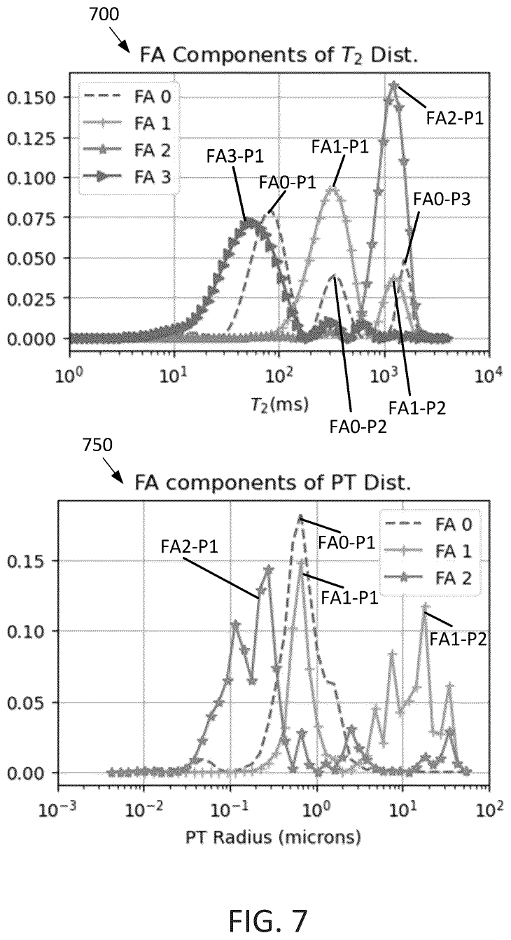

FIG. 7 includes two different graphs of plots that represent the decomposition of pore throat size distribution and NMR T2 distribution, respectively generated using analytical methods, such as factor analysis. Graph 700 of FIG. 7 includes plots of data generated by processing NMR relaxation time data and graph 750 includes plots of data generated by capillary pressure data. Graph 700 includes a set of factor analysis plots. The factor analysis plots of graph 700 include FA0 plot, FA1 plot, FA2 plot, and FA3 plot. As such, each FA plot of graph 700 may be referred to as a factor analysis plot. Graph 700 includes various peaks (FA0-1, FA0-2, FA0-3, FA1-P1, FA1-P2, FA2-P1, and FA3-P1) for each of the respective plots (FA0, FA1, FA2, and FA3). Ideally, each respective factor analysis operation should generate peaks that do not overlap with peaks from other factor analysis. Since, however, collected data may include noise and a limited number of samples, peaks from the different operations may have peaks that overlap.

In graph 700, the FA0 plot includes three different peaks (FA0-P1, FA0-P2, and FA0-P3) that overlap with peaks of the other FA plots. The FA0-P1 peak overlaps with the FA3-P1 peak, the FA0-P2 peak overlaps with the FA1-P1 peak, and the FA0-P3 peak overlaps with the FA2-P1 peak. The FA1 plot has two peaks, a first peak FA1-P1 that overlaps with the FA0-P2 peak and the FA1-P2 peak that overlaps with the FA2-P1 peak. A set of rules or conventions may be used to identify peaks that may be associated with a specific classification of pore size. This set of rules may identify that for each respective factor only one peak located in a span of T2 times should be associated with a pore type of micro, meso, or macro. As such data associated with peaks FA3-P1, FA1-P1, and FA2-P1 may be associated with a respective pore type. To determine which peak corresponds to what pore type may require analysis of a set of collected capillary pressure data. Data associated with plot FA0 may be discarded as content identified by that analysis may already be covered by the FA1, FA2, and FA3 analysis. This may allow for determinations to be made that classifies the FA1 data as being associated with a meso pore type, that classifies the FA2 data as being associated with the macro pore type, and that the FA3 data should be classified as the micro pore type.

Graph 750 of FIG. 7 includes plots of data collected by a capillary pressure test. Here, three different plots (FA0, FA1, and FA2) are generated. Each of the plots in graph 750 include data that shows peaks at different pore throat sizes. Peaks in graph 750 include FA1-P1, FA1-P2, FA2-P1, and FA3-P1. In order to identify three distinct peaks in graph 750 that do not overlap data associated with some of the peaks may be ignored. Since peak FA1-P1 overlaps with peak FA0-P1 in graph 750, data associated with the FA1-P1 peak may be ignored. Data associated with peaks FA2-P1, FA0-P1, and FA1-P2 may be associated with respective pore types of micro, meso, and macro. This means that data from plot FA0 may be classified as being meso pore data, that data from plot FA2 may be classified as being micro pore data, and that data from plot FA1 be classified as macro pore data.

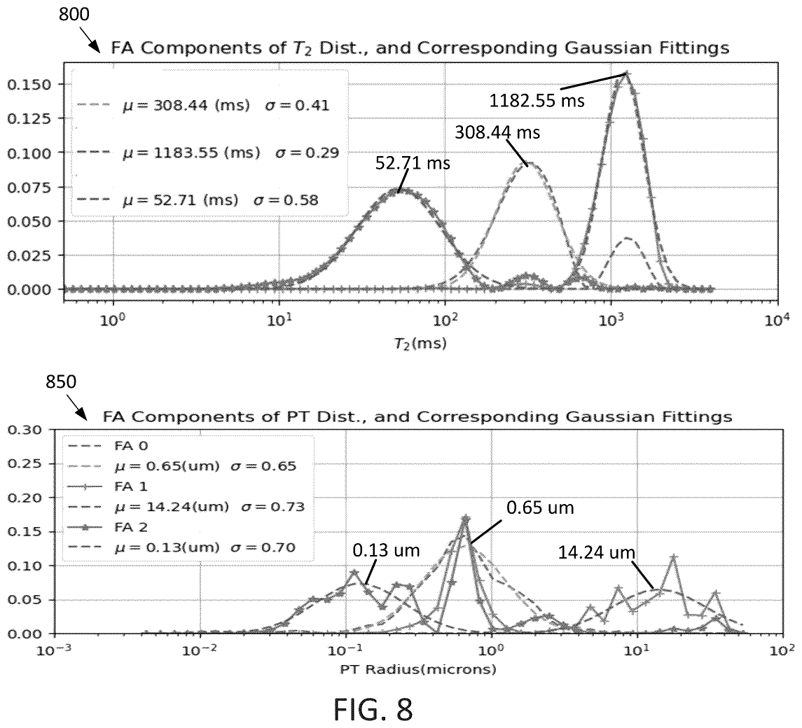

Once the main peaks of the NMR T2 distributions of graph 700 and the capillary pressure pore throat sizes are identified, data associated with these peaks may be used to form Gaussian distributions when sets of new plots are graphed. FIG. 8 illustrates the results of organizing the data of FIG. 7 into respective sets of Gaussian distributions. Graph 800 includes a set of curves with T2 peaks at 52.71 milliseconds (ms), 308.44 ms, and 1182.55 ms that were identified from Gaussian distributions of data associated with the FA3-P1, FA1-P1, and FA2-P1 peaks of graph 700 of FIG. 7.

Graph 850 includes a set of curves with peaks of pore throat size located at 0.13 micro-meters/microns (um), 0.65 um, and 14.24 um. These peaks were identified based on Gaussian distributions of the FA0 data, FA1 data, and FA2 plots of graph 750 of FIG. 7.

Once the locations of respective peaks associated with processed NMR relaxation time data and capillary pressure pore throat analysis data have been identified, three different conversion factors that associate different T2 range of NMR data with specific pore throat range of capillary pressure data. An analysis of this data may also be used to identify pore throat size cutoff values. Such cutoff values may mark boundaries between pore sizes of a micro pore type and a meso pore type, a meso pore type and a macro pore type, and/or a macro pore type cutoff value for example. As such, the Gaussian distributions allow a spectrum of pore throat sizes that correspond to particular conversion factors as shown in table 1. The data of table 1 identifies peaks in a T2 distributions, pore throat radius size distribution, factors that convert T2 distribution data to pore throat size distributions, and cutoff size locations for three different size ranges (that respectively correspond to micro, meso, and macro pore types) of pores in a rock sample. The conversion factors identified in table 1 are in the form of microns per millisecond. The data of table 1 allows for an NMR device to be deployed in a wellbore such that evaluations regarding petrophysical parameters of rock structures, including carbonate rock structures, can be made without additional capillary pressure testing. Such petrophysical parameters may include lithology, porosity, water saturation, permeability, and capillary pressure. As such, the conversion factors identified in a lab can be used on data collected by the NMR device deployed in the wellbore.

TABLE 1
NMR T2 - Pore Throat Data and Conversion Factors

| Pore | T2 Dist. | PT Radius Dist. | Conversion Factor | Cutoff |
|---|---|---|---|---|
| Type | (ms) | (microns) | (microns/ms) | (microns) |
| Micro | 52.71 | 0.13 | 0.13/52.71 | 0.2897 |
| Meso | 308.44 | 0.65 | 0.65/308.44 | N/A |
| Macro | 1183.55 | 14.14 | 14.14/1183.55 | 2.8574 |

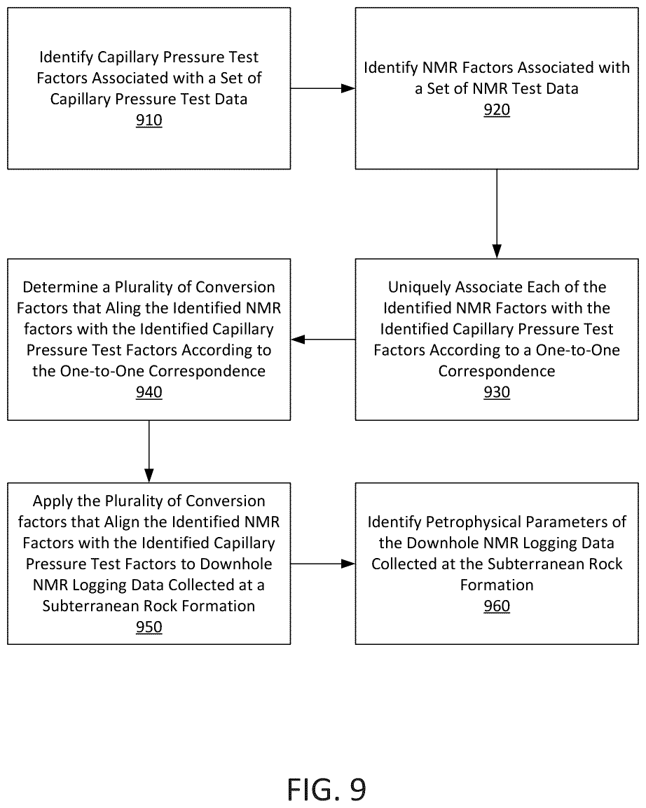

FIG. 9 illustrates actions that may be performed when factors are identified that allow data collected by a nuclear magnetic resonance (NMR) device to be adjusted to correspond to data associated with pores contained within rocks. At block 910 a plurality of capillary pressure test factors associated with a set of capillary pressure test data may be identified. The set of capillary pressure test data may have been collected in a laboratory using equipment that performs an MICP test on one or more core samples that were extracted from the Earth. Techniques used to identify the factors associated with the capillary pressure test data may be identified by the factor analysis operations discussed in respect to FIG. 7 and by generating the Gaussian distributions discussed in respect to FIG. 8. The factors associated with the capillary pressure test data may correspond to a respective pore type, such as a micro pore type, a meso pore type, and a macro pore type that each have a respective range of pore sizes. Since MICP tests may identify pore throat sizes, the factors associated with the capillary pressure test data may correspond to pore throat size.

At block 920 a plurality of nuclear magnetic resonance (NMR) factors associated with a set of nuclear magnetic resonance (NMR) training data may be identified. The set of NMR training data may include T2 distributions generated from data collected in the laboratory using an NMR device. Tests performed by the NMR device may have been performed on the same rock core samples used to collect the capillary pressure test data. Techniques used to identify the NMR factors may be identified by the factor analysis plots discussed in respect to FIG. 7. This may include identifying relevant data groupings according to the rules that identify that for each respective factor only one peak located in a span of T2 times should be associated with a pore type of micro, meso, or macro. As such, at block 930 each of the NMR factors identified at block 920 may be associated with the identified capillary pressure test factors according to a one-to-one correspondence. This one-to-one correspondence could associate a first NMR factor with a first capillary pressure test factor, a second NMR factor with a second capillary pressure test factor, and a third NMR factor with a third capillary pressure test factor.

This process may include ignoring or discounting some data such that Gaussian distributions can be generated for only a specified number of porosity related classifications. When three pore types are used, respective Gaussian distributions may be associated with or classified as belonging to one of a micro pore type, a meso pore type, and a macro pore type. Each of the Gausian distributions generated from the collected capillary pressure test data and NMR data may be identified as corresponding to one of pore types based on a rule that dictates the one-to-one correspondence. The peaks of respective Gaussian distributions may be identified and a span of pore sizes associated with each of the Gaussian distributions may be identified.

At block 940 a plurality of conversion factors may be identified. These conversion factors may align the NMR factors with the capillary pressure test factors according to the one-to-one correspondence. As discussed in respect to table 1, a conversion factor may be in the form of microns per millisecond.

Once conversion factors are identified, the NMR device may be deployed in a wellbore where strata that may be similar to the rocks tested in the laboratory (e.g., rocks that include carbonate minerals) may be located. The NMR device may then collect data at a subterranean rock formation when deployed downhole at the wellbore. Actions that occur at block 950 may include applying the plurality of conversion factors that aligns the identified NMR factors with the identified capillary pressure test factors according to the one-to-one correspondence to downhole NMR logging data collected at a subterranean rock formation. Before the conversion factors are applied, the factor analysis operations discussed in respect to FIG. 7 may be performed and Gaussian distributions may be identified as discussed in respect to FIG. 8. As such, by applying multiple conversion factors to downhole NMR logging data may constrain data associated with a particular pore type to be within ranges limited by the cutoff values of table 1. At block 960, one or more petrophysical parameters of the subterranean rock formation may be identified based on the adjusted conversion factors applied to the NMR logging data collected at the subterranean rock formation.

Techniques of the present disclosure may, therefore, may derive conversion factors for each pore type based on the Gaussian fitting when values of table 1 are identified. Micro and macro cutoffs for pore throat distributions may be identified based on factor analysis of MICP pore throat distributions. These cutoffs may be located at intersections of the Gaussian fittings of factor analysis components of pore throat distributions.

Additionally, the T2 distribution of each sample may be decomposed into three Gaussian components (e.g., NMR factors) with the constraints defined by the three pore positions identified based on the factor analysis of MICP data. The three Gaussian components may be interpreted as micro, meso, and macro pore types. Each Gaussian component of NMR T2 distribution may be converted into a corresponding pore type in pore throat spectrum, with the conversion factors defined in Table 1. Partial porosities of the subterranean rock formation may then be identified.

In yet other instances, techniques of the present disclosure may include decomposing the pore throat distribution of each sample into three Gaussian components (e.g., capillary pressure factors) with constraints set by a rule associated with a set of (e.g., three) pore positions. Converting each Gaussian components of NMR T2 distribution into a corresponding pore type in pore throat spectrum. These techniques may not only decompose NMR T2 distributions and MICP pore throat distributions into micro, meso, and macro pore types, yet may also compute partial porosities for each pore type as well. Furthermore, pore types from MICP and NMR data may be compared. This may include displaying plots of partial porosities. Partial porosities from MICP and NMR data may be compared to identify whether match well for micro, meso, and macro pore type results correspond to a threshold degree.

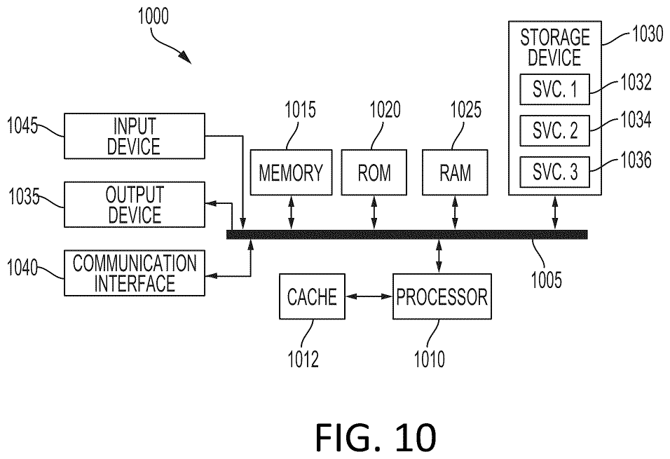

FIG. 10 illustrates an example computing device architecture which can be employed to perform any of the systems and techniques described herein. In some examples, the computing device 1000 architecture can be integrated with tools described herein. The components of the computing device architecture 1000 are shown in electrical communication with each other using a connection 1005, such as a bus. The example computing device architecture 1000 includes a processing unit (CPU or processor) 1010 and a computing device connection 1005 that couples various computing device components including the computing device memory 1015, such as read only memory (ROM) 1020 and random access memory (RAM) 1025, to the processor 1010.

The computing device architecture 1000 can include a cache of high-speed memory connected directly with, in close proximity to, or integrated as part of the processor 1010. The computing device architecture 1000 can copy data from the memory 1015 and/or the storage device 1030 to the cache 1012 for quick access by the processor 1010. In this way, the cache can provide a performance boost that avoids processor 1010 delays while waiting for data. These and other modules can control or be configured to control the processor 1010 to perform various actions. Other computing device memory 1015 may be available for use as well. The memory 1015 can include multiple different types of memory with different performance characteristics. The processor 1010 can include any general-purpose processor and a hardware or software service, such as service 1 1032, service 2 1034, and service 3 1036 stored in storage device 1030, configured to control the processor 1010 as well as a special-purpose processor where software instructions are incorporated into the processor design. The processor 1010 may be a self-contained system, containing multiple cores or processors, a bus, memory controller, cache, etc. A multi-core processor may be symmetric or asymmetric.

To enable user interaction with the computing device architecture 1000, an input device 1045 can represent any number of input mechanisms, such as a microphone for speech, a touch-sensitive screen for gesture or graphical input, keyboard, mouse, motion input, speech and so forth. An output device 1035 can also be one or more of a number of output mechanisms known to those of skill in the art, such as a display, projector, television, speaker device, etc. In some instances, multimodal computing devices can enable a user to provide multiple types of input to communicate with the computing device architecture 1000. The communications interface 1040 can generally govern and manage the user input and computing device output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof. The storage device 1030 can include services 1032, 1034, 1036 for controlling the processor 1010. Other hardware or software modules are contemplated. The storage device 1030 can be connected to the computing device connection 1005. In one aspect, a hardware module that performs a particular function can include the software component stored in a computer-readable medium in connection with the necessary hardware components, such as the processor 1010, connection 1005, output device 1035, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative Aspects of the disclosure include:

Aspect 1: May be a method comprising identifying a plurality of capillary pressure test factors associated with a set of capillary pressure test data, wherein the set of capillary pressure test data is associated with one or more rock samples; identifying a plurality of nuclear magnetic resonance (NMR) factors associated with a set of nuclear magnetic resonance (NMR) training data, wherein the set of NMR training data is associated with the one or more rock samples; uniquely associating each respective factor of the identified NMR factors with each of the identified capillary pressure test factors; determining a plurality of conversion factors that aligns the identified NMR factors with the identified capillary pressure test factors according to a one-to-one correspondence; applying the plurality of conversion factors that aligns the identified NMR factors with the identified capillary pressure test factors according to the one-to-one correspondence to downhole NMR logging data collected at a subterranean rock formation; and identifying one or more petrophysical parameters of the subterranean rock formation based on the adjusted conversion factors applied to the NMR logging data collected at the subterranean rock formation.

Aspect 2: The method of Aspect 1, wherein each of the identified capillary pressure test factors uniquely corresponds to respective pore types of a plurality of pore types of the one or more rock samples, and the plurality of pore types includes a micro pore type, a meso pore type, and a macro pore type.

Aspect 3: The method of Aspect 1 or 2, wherein each respective conversion factor of the plurality of conversion factors are associated with a respective pore type of the plurality of pore types based on the one-to-one correspondence, and the micro pore type corresponds to a first range of pore sizes, the meso pore type corresponds to a second range of pore sizes, and a macro pore type corresponds to a third range of pore sizes.

Aspect 4: The method of any of Aspects 1 through 3 further comprising collecting the set of capillary pressure test data based on a capillary pressure test performed on the one or more rock samples, wherein each of the plurality of capillary pressure test factors are identified from a Gaussian distribution associated with the set of capillary pressure test data; and collecting the set of NMR training data based on an NMR test performed on the one or more rock samples, wherein each of the plurality of NMR factors are identified from a Gaussian distribution associated with the set of NMR training data.

Aspect 5: The method of and of Aspects 1 through 4 further comprising initiating operation of an NMR sensing device in a wellbore where the subterranean rock formation is located.

Aspect 6: The method of any of Aspects 1 through 5 further comprising providing a first type of fluid to the wellbore to displace a second type of fluid located at the subterranean rock formation, wherein the NMR sensing device collects data based on the first type of fluid displacing the second type of fluid.

Aspect 7: The method of any of Aspects 1 through 6, wherein the one or more rock samples and the subterranean rock formation include carbonite minerals.

Aspect 8: A non-transitory computer-readable storage media having embodied thereon instructions executable by one or more processors to implement a method comprising: identifying a plurality of capillary pressure test factors associated with a set of capillary pressure test data, wherein the set of capillary pressure test data is associated with one or more rock samples; identifying a plurality of nuclear magnetic resonance (NMR) factors associated with a set of nuclear magnetic resonance (NMR) training data, wherein the set of NMR training data is associated with the one or more rock samples; uniquely associating each respective factor of the identified NMR factors with each of the identified capillary pressure test factors; determining a plurality of conversion factors that aligns the identified NMR factors with the identified capillary pressure test factors according to a one-to-one correspondence; applying the plurality of conversion factors that aligns the identified NMR factors with the identified capillary pressure test factors according to the one-to-one correspondence to downhole NMR logging data collected at a subterranean rock formation; and identifying one or more petrophysical parameters of the subterranean rock formation based on the adjusted conversion factors applied to the NMR logging data collected at the subterranean rock formation.

Aspect 9: The non-transitory computer-readable storage medium of Aspect 8, wherein each of the identified capillary pressure test factors uniquely corresponds to respective pore types of a plurality of pore types of the one or more rock samples, and the plurality of pore types includes a micro pore type, a meso pore type, and a macro pore type.

Aspect 10: The non-transitory computer-readable storage medium of Aspect 9, wherein each respective conversion factor of the plurality of conversion factors are associated with a respective pore type of the plurality of pore types based on the one-to-one correspondence, and the micro pore type corresponds to a first range of pore sizes, the meso pore type corresponds to a second range of pore sizes, and a macro pore type corresponds to a third range of pore sizes.

Aspect 11: The non-transitory computer-readable storage medium of any of Aspects 8 through 10, wherein the one or more processors execute the instructions to collect the set of capillary pressure test data based on a capillary pressure test performed on the one or more rock samples, wherein each of the plurality of capillary pressure test factors are identified from a Gaussian distribution associated with the set of capillary pressure test data; and collect the set of NMR training data based on an NMR test performed on the one or more rock samples, wherein each of the plurality of NMR factors are identified from a Gaussian distribution associated with the set of NMR training data.

Aspect 12: The non-transitory computer-readable storage medium of any of Aspects 8 through 11, wherein the one or more processors execute the instructions to initiate operation of an NMR sensing device in a wellbore where the subterranean rock formation is located.

Aspect 13: The non-transitory computer-readable storage medium of any of Aspects 8 through 12, wherein a first type of fluid is provided to the wellbore to displace a second type of fluid located at the subterranean rock formation, and wherein the NMR sensing device collects data based on the first type of fluid displacing the second type of fluid.

Aspect 14: The non-transitory computer-readable storage medium of any of Aspects 9 through 13, wherein the one or more rock samples and the subterranean rock formation include carbonite minerals.

Aspect 15: A system comprising a memory; and one or more processors that execute instructions out of the memory to: identify a plurality of capillary pressure test factors associated with a set of capillary pressure test data, wherein the set of capillary pressure test data is associated with one or more rock samples; identify a plurality of nuclear magnetic resonance (NMR) factors associated with a set of nuclear magnetic resonance (NMR) training data, wherein the set of NMR training data is associated with the one or more rock samples; uniquely associate each respective factor of the identified NMR factors with each of the identified capillary pressure test factors; determine a plurality of conversion factors that aligns the identified NMR factors with the identified capillary pressure test factors according to a one-to-one correspondence; apply the plurality of conversion factors that aligns the identified NMR factors with the identified capillary pressure test factors according to the one-to-one correspondence to downhole NMR logging data collected at a subterranean rock formation; and identify one or more petrophysical parameters of the subterranean rock formation based on the adjusted conversion factors applied to the NMR logging data collected at the subterranean rock formation.

Aspect 16: The system of Aspect 15, wherein each of the identified capillary pressure test factors uniquely corresponds to respective pore types of a plurality of pore types of the one or more rock samples, and the plurality of pore types includes a micro pore type, a meso pore type, and a macro pore type.

Aspect 17: The system of Aspect 16, wherein each respective conversion factor of the plurality of conversion factors are associated with a respective pore type of the plurality of pore types based on the one-to-one correspondence, and the micro pore type corresponds to a first range of pore sizes, the meso pore type corresponds to a second range of pore sizes, and a macro pore type corresponds to a third range of pore sizes.

Aspect 18: The system of any of Aspects 15 through 17, further comprising: a capillary pressure test apparatus that collects the set of capillary pressure test data based on a capillary pressure test performed on the one or more rock samples, wherein each of the plurality of capillary pressure test factors are identified from a Gaussian distribution associated with the set of capillary pressure test data; and an NMR device that collects the set of NMR training data based on an NMR test performed on the one or more rock samples, wherein each of the plurality of NMR factors are identified from a Gaussian distribution associated with the set of NMR training data.

Aspect 19: The system of any of Aspects 15 through, wherein the one or more processors execute the instructions to initiate operation of an NMR sensing device in a wellbore where the subterranean rock formation is located.

Aspect 20: The system of any of Aspects 15 through 19, wherein: a first type of fluid is provided to the wellbore to displace a second type of fluid located at the subterranean rock formation, wherein the NMR sensing device collects data based on the first type of fluid displacing the second type of fluid.

What is claimed is:

1. A method comprising:
identifying a plurality of capillary pressure test factors associated with a set of capillary pressure test data, wherein the set of capillary pressure test data is associated with one or more rock samples;
identifying a plurality of nuclear magnetic resonance (NMR) factors associated with a set of nuclear magnetic resonance (NMR) training data, wherein the set of NMR training data is associated with the one or more rock samples;
uniquely associating each respective factor of the identified NMR factors with each of the identified capillary pressure test factors;
determining a plurality of conversion factors that aligns the identified NMR factors with the identified capillary pressure test factors according to a one-to-one correspondence;
applying the plurality of conversion factors that aligns the identified NMR factors with the identified capillary pressure test factors according to the one-to-one correspondence to downhole NMR logging data collected at a subterranean rock formation; and
identifying one or more petrophysical parameters of the subterranean rock formation based on the adjusted conversion factors applied to the NMR logging data collected at the subterranean rock formation.

2. The method of claim 1, wherein:
each of the identified capillary pressure test factors uniquely corresponds to respective pore types of a plurality of pore types of the one or more rock samples, and
the plurality of pore types includes a micro pore type, a meso pore type, and a macro pore type.

3. The method of claim 2, wherein:
each respective conversion factor of the plurality of conversion factors are associated with a respective pore type of the plurality of pore types based on the one-to-one correspondence, and
the micro pore type corresponds to a first range of pore sizes, the meso pore type corresponds to a second range of pore sizes, and a macro pore type corresponds to a third range of pore sizes.

4. The method of claim 1, further comprising:
collecting the set of capillary pressure test data based on a capillary pressure test performed on the one or more rock samples, wherein each of the plurality of capillary pressure test factors are identified from a Gaussian distribution associated with the set of capillary pressure test data; and
collecting the set of NMR training data based on an NMR test performed on the one or more rock samples, wherein each of the plurality of NMR factors are identified from a Gaussian distribution associated with the set of NMR training data.

5. The method of claim 1, further comprising:
initiating operation of an NMR sensing device in a wellbore where the subterranean rock formation is located.

6. The method of claim 5, further comprising:
providing a first type of fluid to the wellbore to displace a second type of fluid located at the subterranean rock formation, wherein the NMR sensing device collects data based on the first type of fluid displacing the second type of fluid.

7. The method of claim 1, wherein the one or more rock samples and the subterranean rock formation include carbonite minerals.

8. A non-transitory computer-readable storage media having embodied thereon instructions executable by one or more processors to implement a method comprising:
identifying a plurality of capillary pressure test factors associated with a set of capillary pressure test data, wherein the set of capillary pressure test data is associated with one or more rock samples;
identifying a plurality of nuclear magnetic resonance (NMR) factors associated with a set of nuclear magnetic resonance (NMR) training data, wherein the set of NMR training data is associated with the one or more rock samples;
uniquely associating each respective factor of the identified NMR factors with each of the identified capillary pressure test factors;
determining a plurality of conversion factors that aligns the identified NMR factors with the identified capillary pressure test factors according to a one-to-one correspondence;
applying the plurality of conversion factors that aligns the identified NMR factors with the identified capillary pressure test factors according to the one-to-one correspondence to downhole NMR logging data collected at a subterranean rock formation; and
identifying one or more petrophysical parameters of the subterranean rock formation based on the adjusted conversion factors applied to the NMR logging data collected at the subterranean rock formation.

9. The non-transitory computer-readable storage medium of claim 8, wherein:
each of the identified capillary pressure test factors uniquely corresponds to respective pore types of a plurality of pore types of the one or more rock samples, and
the plurality of pore types includes a micro pore type, a meso pore type, and a macro pore type.

10. The non-transitory computer-readable storage medium of claim 9, wherein:
each respective conversion factor of the plurality of conversion factors are associated with a respective pore type of the plurality of pore types based on the one-to-one correspondence, and
the micro pore type corresponds to a first range of pore sizes, the meso pore type corresponds to a second range of pore sizes, and a macro pore type corresponds to a third range of pore sizes.

11. The non-transitory computer-readable storage medium of claim 8, wherein the one or more processors execute the instructions to:
collect the set of capillary pressure test data based on a capillary pressure test performed on the one or more rock samples, wherein each of the plurality of capillary pressure test factors are identified from a Gaussian distribution associated with the set of capillary pressure test data; and
collect the set of NMR training data based on an NMR test performed on the one or more rock samples, wherein each of the plurality of NMR factors are identified from a Gaussian distribution associated with the set of NMR training data.

12. The non-transitory computer-readable storage medium of claim 9, wherein the one or more processors execute the instructions to:
initiate operation of an NMR sensing device in a wellbore where the subterranean rock formation is located.

13. The non-transitory computer-readable storage medium of claim 12, wherein:
a first type of fluid is provided to the wellbore to displace a second type of fluid located at the subterranean rock formation, wherein the NMR sensing device collects data based on the first type of fluid displacing the second type of fluid.

14. The non-transitory computer-readable storage medium of claim 8, wherein the one or more rock samples and the subterranean rock formation include carbonite minerals.

15. A system comprising:
a memory; and
one or more processors that execute instructions out of the memory to:
identify a plurality of capillary pressure test factors associated with a set of capillary pressure test data, wherein the set of capillary pressure test data is associated with one or more rock samples;
identify a plurality of nuclear magnetic resonance (NMR) factors associated with a set of nuclear magnetic resonance (NMR) training data, wherein the set of NMR training data is associated with the one or more rock samples;
uniquely associate each respective factor of the identified NMR factors with each of the identified capillary pressure test factors;
determine a plurality of conversion factors that aligns the identified NMR factors with the identified capillary pressure test factors according to a one-to-one correspondence;
apply the plurality of conversion factors that aligns the identified NMR factors with the identified capillary pressure test factors according to the one-to-one correspondence to downhole NMR logging data collected at a subterranean rock formation; and
identify one or more petrophysical parameters of the subterranean rock formation based on the adjusted conversion factors applied to the NMR logging data collected at the subterranean rock formation.

16. The system of claim 15, wherein:
each of the identified capillary pressure test factors uniquely corresponds to respective pore types of a plurality of pore types of the one or more rock samples, and
the plurality of pore types includes a micro pore type, a meso pore type, and a macro pore type.

17. The system of claim 16, wherein:
each respective conversion factor of the plurality of conversion factors are associated with a respective pore type of the plurality of pore types based on the one-to-one correspondence, and
the micro pore type corresponds to a first range of pore sizes, the meso pore type corresponds to a second range of pore sizes, and a macro pore type corresponds to a third range of pore sizes.

18. The system of claim 15, further comprising:
a capillary pressure test apparatus that collects the set of capillary pressure test data based on a capillary pressure test performed on the one or more rock samples, wherein each of the plurality of capillary pressure test factors are identified from a Gaussian distribution associated with the set of capillary pressure test data; and
an NMR device that collects the set of NMR training data based on an NMR test performed on the one or more rock samples, wherein each of the plurality of NMR factors are identified from a Gaussian distribution associated with the set of NMR training data.

19. The system of claim 16, wherein the one or more processors execute the instructions to:
initiate operation of an NMR sensing device in a wellbore where the subterranean rock formation is located.

20. The system of claim 12, wherein:
a first type of fluid is provided to the wellbore to displace a second type of fluid located at the subterranean rock formation, wherein the NMR sensing device collects data based on the first type of fluid displacing the second type of fluid.
